(19) United States
(12) Patent Application Publication
(10) Pub. No.: US 2008/0117848 A1
(43) Pub. Date: May 22, 2008

(54) COMMUNICATION SYSTEM AND METHODS FOR POWER MANAGEMENT THEREOF

(75) Inventors: Muh-Rong Yang, Taipei (TW); Gin-Kou Ma, Hsinchu County (TW); Cheng-Hsiang Chiu, Hsinchu City (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, HSINCHU (TW)

(21) Appl. No.: 11/753,532

(22) Filed: May 24, 2007

(30) Foreign Application Priority Data
Nov. 17, 2006 (TW) TW95142548

(51) Int. Cl. G08C 17/00

(52) U.S. Cl. 370/311

(57) ABSTRACT

A method for power management in a communication system is disclosed. The communication system is capable of operating in a first mode, and comprises at least one device having first module corresponding to the first mode. The device can be configured to a normal mode or a power saving mode. First, map data is retrieved from frame data, in which the map data indicates a first time point corresponding to the first mode. Then, when the communication system operates in the first mode, the first module of the device is determined to be configured to the normal mode or the power saving mode according to the first time point.

### BACKGROUND OF THE INVENTION

1. Field of the Invention

The invention relates to a communication system, and more particularly, to a power management method using time slots fixed or varied with synchronization frame for reducing total power consumption of the system.

2. Description of the Related Art

One significant goal in communication system design is reduced power consumption. In general, at the circuit level, power consumption can be divided into static and dynamic power consumption. Dynamic power consumption is directly related to the capacitance of load capacitor, operating voltage and operating frequency. Therefore, methods of dynamic voltage and frequency scaling (DVFS) and dynamic frequency scaling are proposed to reduce the power dissipation.

Conventional methods for reducing power consumption are considered at circuit level. One typical method reduces voltage by varying the output of the regulator. However, changing the design of the regulator is not practical and saves minimal power, increasing design cost of the system. Further, one conventional radio frequency (RF) chip can only be switched to a receiving or a transmission mode, failing to reduce power dissipation effectively.

### BRIEF SUMMARY OF THE INVENTION

The invention provides a communication system and related power management method thereof. The power consumption is considered at the system level using time slot fixed or varied with synchronization frame to enable or disable related modules. Moreover, techniques which are considered at circuit level, such as DVFS method, can be combined with the invention to further reduce power consumption.

An exemplary embodiment of a method for power management in a communication system is provided. The communication system operates in a first mode and comprises at least one device, wherein the device comprises a first module corresponding to the first mode and is configured to a normal mode or a power saving mode. First, map data is retrieved from frame data, wherein the map data indicates a first time point corresponding to the first mode. Then, the first module of the device is determined to be configured to the normal mode or the power saving mode according to the first time point when the communication system operates in the first mode.

The invention also provides a communication system capable of operating in a first mode. The system comprises at least one device and a power management module. The at least one device comprises a first module corresponding to the first mode wherein the device is configured to a normal mode or a power saving mode. The power management module retrieves map data from frame data, wherein the map data indicates a first time point corresponding to the first mode. When the communication system operates in the first mode, the power management module determines the first module of the device is configured to the normal mode or the power saving mode according to the first time point.

### BRIEF DESCRIPTION OF THE DRAWINGS

The invention can be more fully understood by reading the subsequent detailed description and examples with reference to the accompanying drawings, wherein:

FIG. 1 shows an embodiment of a conventional communication system;

FIG. 2 shows a schematic of TDD frame structure applied in a time division duplex (TDD) mode;

FIG. 3 shows an embodiment of a communication system according to the invention;

FIG. 4 is a flowchart of a power management method according to an embodiment of the invention;

FIG. 5 is a flowchart of a power management method applied in a receiving mode according to an embodiment of the invention;

FIG. 6 is a flowchart of a power management method applied in a transmission mode according to an embodiment of the invention;

FIG. 7 is a flowchart of a power management method applied in a transmission mode according to another embodiment of the invention; and

FIG. 8 shows an embodiment of an interrupt application according to the invention.

### DETAILED DESCRIPTION OF THE INVENTION

The following description is one of the best-contemplated mode of carrying out the invention. This description is made for the purpose of illustrating the general principles of the invention and should not be taken in a limiting sense. The scope of the invention is best determined by reference to the appended claims.

The invention provides a method for power management in communication systems capable of performing a time division duplex (TDD) or a half frequency division duplex (H-FDD) protocol. In frame structures of the communication systems, after a mobile station successfully acquires a clear channel for communication, the mobile station uses a dedicated time slot within the frame to transmit (upload) or receive (download) data. The information related to the dedicated time slots for transmitting data and receiving data can be predetermined and thus can be used to control the power state of each module in the communication system. For example, if one of the modules is unnecessary in a specific mode, it can be disabled or shut down. By doing so, all of the modules that are expected to be unused in a specific mode will be disabled and only the necessary modules to perform related operations are enabled such that power consumption is significantly reduced. It is to be understood that the meaning of the term “disable” hereinafter refers to removal of all power from the module or maintenance of only minor power wherein the module itself does not function.

Moreover, each chip in the communication system can be partitioned into several modules in advance according to a usage requirement. According to a given processing sequence, when considered at system level, unnecessary modules can be first disabled, and then enabled at a suitable time point in a specific mode. As a result, power consumption of the system is significantly reduced.

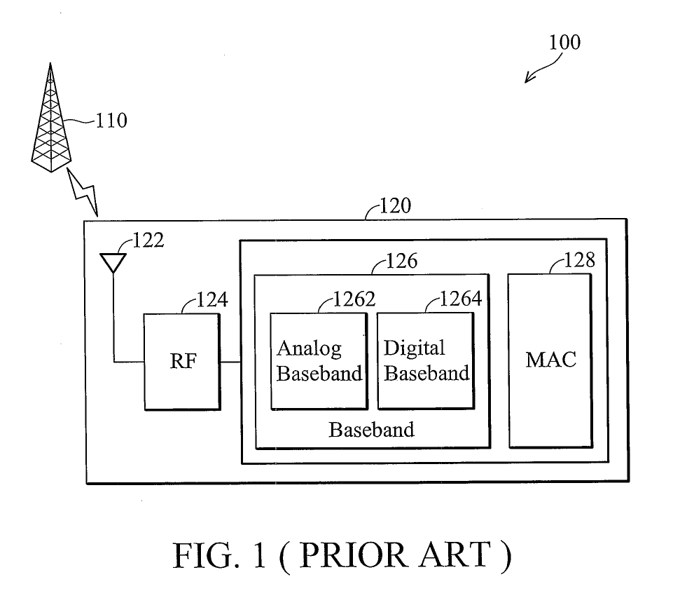

FIG. 1 shows an embodiment of a conventional communication system. Communication system 100 comprises at least a base station (BS) 110 and a mobile station 120. The base station 110 provides a variety of functions, such as radio frequency channels, interface between data link and physical layers, radio resource management, measurement for radio performance, or power control. The mobile station 120 transmits or receives voice or digital data through the base station 110. While transmitting data, the mobile station 120 transmits signals at effectively low power according to an instruction from the base station 110. The mobile station 120 comprises at least an antenna module 122, a radio frequency (RF) chip 124, a base band (BB) chip 126 and a medium access control (MAC) chip 128. The RF chip 124 receives signals transmitted in the air with high frequencies through the antenna module 122 and modulates the signals to signals with acceptable low/medium frequencies for system. The RF chip 124 also modulates the signals in the system with low/medium frequencies up to higher frequencies for transmission purposes. In general, the BB chip 126 can be partitioned into a digital BB module 1264 and an analog BB module 1262. The analog BB module 1262 mainly comprises components capable of handling the mixed signals from an analog to digital converter (ADC) while the digital BB module 1264 mainly comprises components capable of performing channel coding/decoding (CODEC) and digital modulations. The major functions of the MAC chip 128 are executing the communication protocol on the medium access control layer and providing bandwidth allocation, quality of service (QoS) guarantee, scheduling and power management. It is to be understood that the RF chip 124, the BB chip 126 and the MAC chip 128 may comprise several modules or components in which one half of the modules or components are used for transmission (TX) and the other half receive (RX).

To transmit or receive data, signals with a frame structure are transmitted between the base station 110 and the mobile station 120.

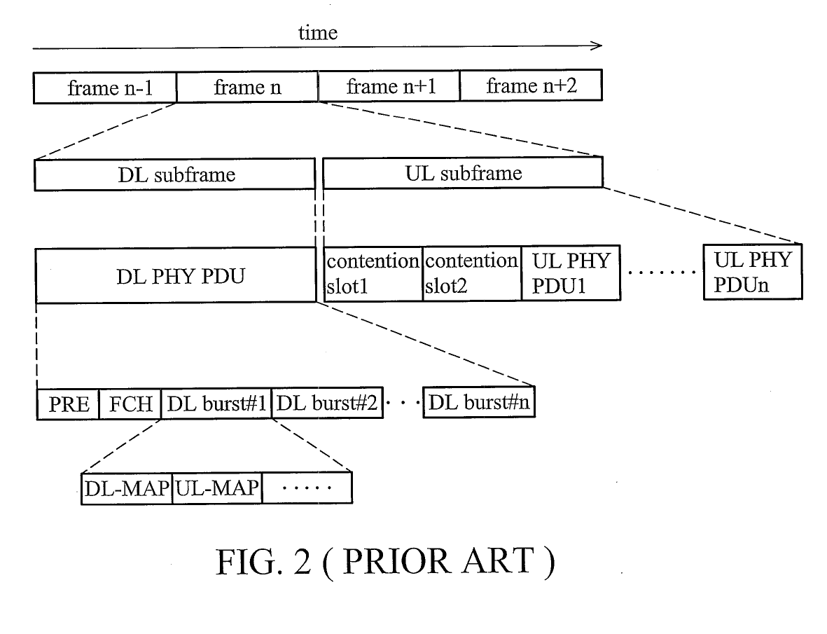

FIG. 2 shows a schematic of TDD frame structure applied in a time division duplex (TDD) mode. As shown in FIG. 2, each TDD frame is divided into a downlink (DL) subframe and uplink (UL) subframe in which the DL subframe occurs prior to the UL subframe. The DL subframe includes a contention slot1, a contention slot2 and one or more uplink physical layer protocol data unit (UL PHY PDUs) fields, wherein the contention slot1 field is for initial ranging, the contention slot2 field is for bandwidth request proposes and the one or more UL PHY PDUs fields include data transmitted from different mobile stations. Map data DL-MAP and UL-MAP, in the first DL burst, indicate slots for downloading (i.e. first time point) and uploading (i.e. second time point), respectively, assigned of the base station. The slots for data downloading and uploading are referred to as receiving (i.e. download) and transmission (i.e. upload) slots respectively. The receiving or transmission slot may be a fixed slot in each frame or slot varied with different frame based on present network status by the base station. Thus, after receiving this information, a mobile station can receive (download) and transmit (upload) data through the base station using the receiving slot and transmission slot, indicated by map dada DL-MAP and UL-MAP, respectively.

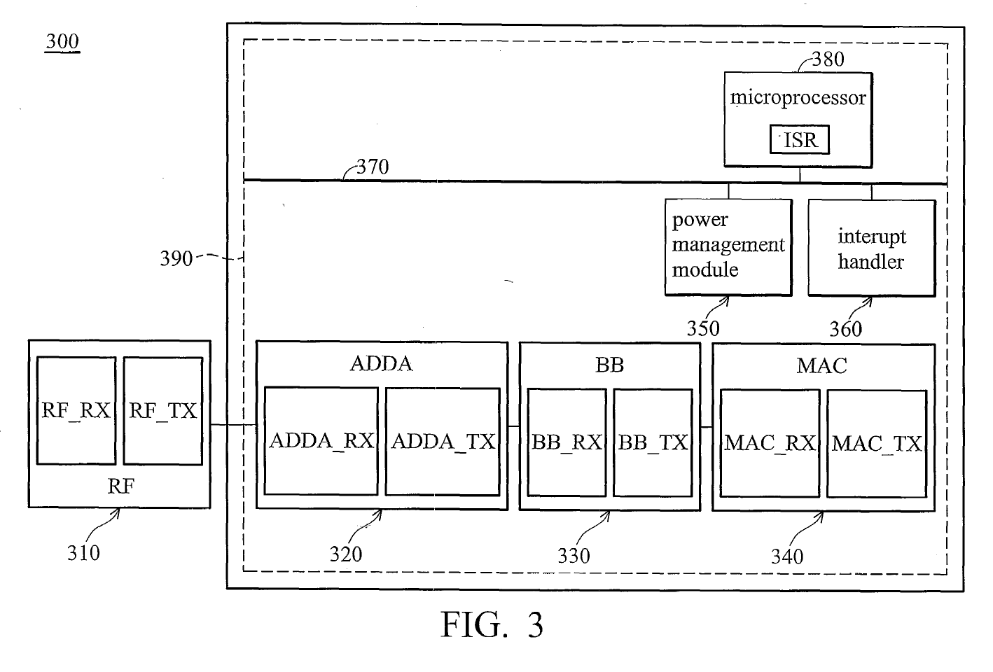

FIG. 3 shows an embodiment of a communication system according to the invention. Communication system 300 comprises at least a radio frequency (RF) chip 310, an analog-digital/digital-analog converter (ADDA) 320, a baseband (BB) chip 330, a medium access control (MAC) chip 340, a power management module 350, an interrupt handler 360 and a microprocessor 380. The power management module 350, the interrupt handler 360 and the microprocessor 380 are coupled to a system bus 370 and exchange information to each other by the system bus 370. The functions of the RF chip 310, the BB chip 330 and the MAC chip 340 are similar to the shown in FIG. 1. The analog-digital/digital-analog converter (ADDA) 320 is capable of performing analog to digital signal conversion (ADC) or digital to analog signal conversion (DAC). It is to be understood that while the analog-digital/digital-analog converter 320 and the BB chip 330 in this embodiment are different modules, the analog-digital/digital-analog converter 320 may be built into the BB chip 330 in other embodiments. The interrupt handler 360 generates several interrupt vectors, and the microprocessor 380 has interrupt service routines (ISR) corresponding to the interrupt vectors providing the interrupt services corresponding thereto.

Moreover, the communication system 300 is capable of operating in a receiving mode (i.e. first mode, RX) for receiving data from the base station or operating in a transmission mode (i.e. second mode, TX) for transmitting data to the base station. The RF chip 310, the analog-digital/digital-analog converter 320, the BB chip 330, and the MAC chip 340 within the communication system 300 are partitioned into receiving modules corresponding to the receiving mode and transmission modules corresponding to the transmission mode respectively. For example, the BB chip 330 is partitioned into a receiving module BB_RX that comprises components needed for receiving data and a transmission module BB_TX that comprises components needed for transmitting data. Similarly, the RF chip 310, the analog-digital/digital-analog converter (ADDA) 320 and the MAC chip 340 are respectively partitioned into receiving modules RF_RX, ADDA_RX and MAC_RX, and transmission modules RF_TX, ADDA_TX and MAC_TX. Each or some of the devices (RF/ADDA/BB/MAC chip) may be configured to a normal mode and a power saving mode. When a device is configured to the normal mode, all components within a module are powered up and all functions enabled. When a device is configured in the power saving mode, unnecessary components within a module are disabled, and only necessary components are powered up. In addition, in this embodiment, the analog-digital/digital-analog converter (ADDA) 320, the BB chip 330, the MAC chip 340, the power management module 350, the interrupt handler 360 and the microprocessor 380 may be integrated in a single ASIC chip or integrated together with the RF chip at the same ASIC chip.

The power management module 350 determines whether the devices (RF/ADDA/BB/MAC chip) are configured to the normal (enable) mode or to the power saving (disable) mode. When the communication system 300 operates in the receiving mode, the transmission modules within the devices 310-340 are unnecessary, and thus the power management module 350 configures the transmission modules to the power saving mode. Alternatively, when the communication system 300 operates in the transmission mode, the receiving modules within the devices 310-340 are unnecessary, and thus the power management module 350 configures the receiving modules to the power saving mode. It is to be understood that although the receiving modules or the transmission modules of the devices RF/ADDA/BB/MAC, in this embodiment, are all configured to the normal mode or the power saving mode, the invention is not limited thereto, and can also be applied to control only one or some modules of the device to the normal mode or the power saving mode. Specially, the invention may also be applied in a communication system without a microprocessor or related interrupt handler.

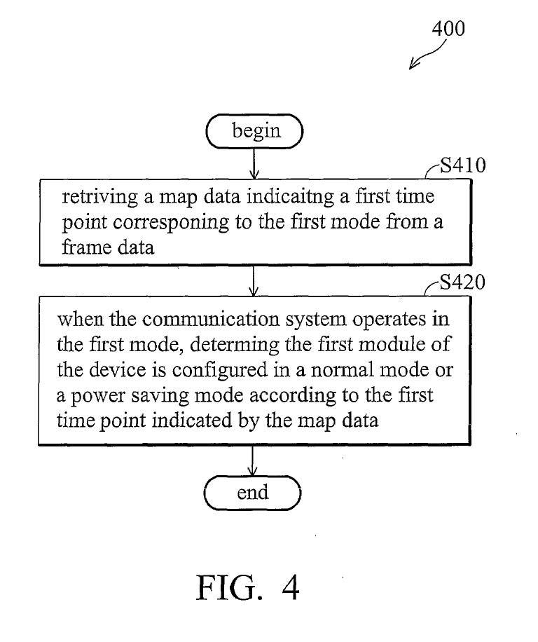

FIG. 4 is a flowchart of a power management method according to an embodiment of the invention. First, in step S410, map data is retrieved from frame data. As previously disclosed, the map data DL-MAP and UL-MAP indicate a receiving slot (first time point) and a transmission slot (second time point) corresponding to the receiving and transmission modes respectively. Thus, in step S420, when the communication system operates in the receiving mode (or the transmission mode), the power management module 350 determines that the receiving modules (or the transmission modules) of the devices are configured to a normal mode or a power saving mode according to the time point related to the receiving slot (or the transmission slot) indicated by the DL-MAP (or the UP-MAP). Since map data UL-MAP and DL-MAP can be obtained at the beginning of each frame data (e.g. the first DL burst), it is possible for the power management module 350 to configure the modes of the transmission and receiving modules to the normal mode or the power saving mode effectively and enable necessary modules at suitable time point according to the specific operating mode (transmission mode or receiving mode). As a result, the overall power consumption of the system is significantly reduced.

Furthermore, to operate normally, each device requires a special setup time for setting up or warming up the device. For example, the RF chip requires a setup time to await all modules to be ready so that it can be used properly. Therefore, to operate, one module must be enabled before a time interval equals or exceeds its setup time. The setup time of a specific device depends on the system specification, and can be obtained from its data sheet. Thus, the time interval which equals the setup time of the device can be known in advance from its data sheet.

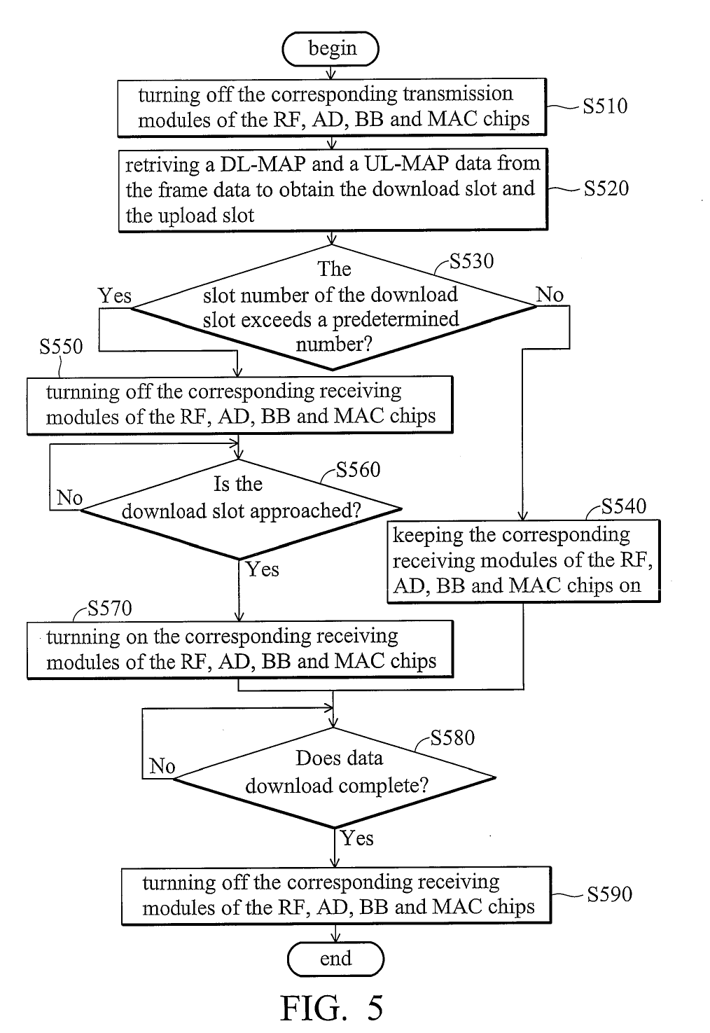

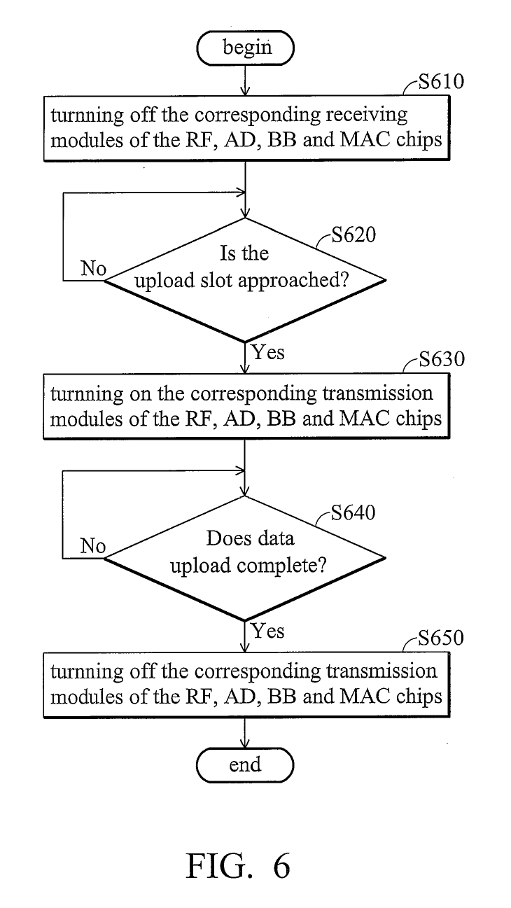

FIGS. 5 and 6 are flowcharts of a power management method applied in a receiving mode and a transmission mode, respectively, according to an embodiment of the invention. As shown in FIGS. 3 and 5, first, the system operates in the receiving mode, so transmission modules are unneeded. Thus, the corresponding transmission modules RF_TX, ADDA_TX, BB_TX and MAC_TX of the RF, ADDA, BB and MAC chips are respectively disabled (step S510). Meanwhile, the corresponding receiving modules RF_RX, ADDA_RX, BB_RX and MAC_RX of the RF, ADDA, BB and MAC chips are respectively enabled so frame data can be received later. The transmission module is disabled if the transmission module is configured to the power saving mode. The transmission module is enabled if the transmission module is configured to the normal mode. Next, map data DL-MAP and UL-MAP are retrieved from the received frame data respectively to obtain receiving and transmission slots for data download and upload respectively (step S520). Next, it is determined whether a period between current time point and a time point TP1 at an interval prior to a first time point corresponding to the receiving slot exceeds a predetermined threshold (step S530). The period can be determined by calculating the time length from current time point to the time point TP1 by a communication system. If the period between current time point and the time point TP1 exceeds a predetermined threshold, it is determined that the period between current time point and the first time point also exceeds the predetermined threshold. This predetermined threshold depends on the setup time of the device, and can be dynamically adjusted according to the system requirement. The predetermined threshold can be a time interval which equals or exceeds its setup time such that the device can be ready before receiving data thereby. For example, the predetermined threshold can be set to be T1 if the setup time required for the device is equal to T1. If the period between current time point and the time point TP1 is less than or equal to the predetermined threshold (No in step S530), the system will receive data soon, so the corresponding receiving modules RF_RX, ADDA_RX, BB_RX and MAC_RX of the RF, ADDA, BB and MAC chips respectively are kept enabled (step S540). Then, it is determined whether data download is completed (step S580). If so, at a time interval subsequent to the receiving slot, the corresponding receiving modules RF_RX, ADDA_RX, BB_RX and MAC_RX of the RF, ADDA, BB and MAC chips can be disabled (step S590).

If the period between current time point and the time point TP1 exceeds the predetermined threshold (Yes in step S530), the system will not receive data soon, so the corresponding receiving modules RF_RX, ADDA_RX, BB_RX and MAC_RX of the RF, ADDA, BB and MAC chips are respectively disabled (step S550). At the same time, a counter can be used to count down from a counter value that equals the period between current time point and the time point TP1. Therefore, it can be used to determine whether the receiving slot is close enough (step S560). If the counter value is not equal to zero, the receiving slot is not close enough yet (No in step S560), so the corresponding receiving modules RF_RX, ADDA_RX, BB_RX and MAC_RX of the RF, ADDA, BB and MAC chips respectively remain disabled and the counter value is decreased by one. If the counter value is equal to zero, the receiving slot is close enough (i.e. at an interval prior to the receiving slot) and the system is going to receiving data soon (Yes in step S560), so the corresponding receiving modules RF_RX, ADDA_RX, BB_RX and MAC_RX of the RF, ADDA, BB and MAC chips are respectively enabled to set up the modules and to prepare to receive data (step S570). Thus, data or user information transmitted from the base station can be received immediately. After an interval subsequent to the receiving slot, the data download is completed, so the corresponding receiving modules RF_RX, ADDA_RX, BB_RX and MAC_RX of the RF, ADDA, BB and MAC chips are respectively disabled to save power (step S590). It is to be understood that disabling or enabling the modules in steps S510-S590 can be applied to a single module or a plurality of modules.

FIG. 6 is a flowchart of a power management method applied in a transmission mode according to an embodiment of the invention. As shown in FIGS. 3 and 6, first, the system operates in the transmission mode, so the receiving modules are unnecessary. Thus, the corresponding receiving modules RF_RX, ADDA_RX, BB_RX and MAC_RX of the RF, ADDA, BB and MAC chips are respectively disabled (step S610). Since the transmission slot is obtained in step S520, it is then determined whether the transmission slot is close enough by determining steps similar to S560-S570 (step S620). If the transmission slot is not yet close enough (i.e. at an interval prior to the transmission slot) (No in step S620), the system will not transmit data soon, so the corresponding transmission modules RF_TX, ADDA_TX, BB_TX and MAC_TX of the RF, ADDA, BB and MAC chips respectively remain disabled. If the transmission slot is close enough (i.e. at an interval prior to the transmission slot), will transmit data soon (Yes in step S620), so the corresponding transmission modules RF_TX, ADDA_TX, BB_TX and MAC_TX of the RF, ADDA, BB and MAC chips are respectively enabled to set up the modules and prepare to transmit data (step S630). Thus, the communication system can transmit data or user information to the base station. Then, it is determined whether the data upload is completed (step S640). After an interval subsequent to the transmission slot, the data upload is completed, so the corresponding transmission modules RF_TX, ADDA_TX, BB_TX and MAC_TX of the RF, ADDA, BB and MAC chips are respectively disabled to save power (step S650). Again, it is to be understood that disabling or enabling the modules in steps S610-S650 can be applied to a single module or a plurality of modules.

In a WiMAX system, for example, a communication system receives slot arrangement information from a base station to receive and transmit data by a receiving slot and a transmission slot indicated by map data DL-MAP and UL-MAP assigned by the base station according to present network status. The map data DL-MAP indicates which slot is used for the communication system to receive data, while the map data UL-MAP indicates which slot is used for the communication system to transmit data. It is assumed that the frame data is partitioned into 24 slots SLOT[0] to SLOT[23] in which one half of the 24 slots (SLOT[0] to SLOT[11]) receive data and the other half of which (SLOT[12] to SLOT[23]) transmit data. It is also assumed that the 5^{th} slot SLOT[5] and the 15^{th} slot SLOT[15] are assigned to the receiving slot and transmission slot respectively, and the setup time is about one slot. When the communication system operates in the receiving mode, the transmission modules are unnecessary. Thus, the corresponding transmission modules RF_TX, ADDA_TX, BB_TX and MAC_TX of the RF, ADDA, BB and MAC chips are respectively disabled. Meanwhile, a counter can be used to count down from a counter value that equals 4 and the counter value is decreased by one at each slot. The corresponding receiving modules RF_RX, ADDA_RX, BB_RX and MAC_RX of the RF, ADDA, BB and MAC chips are respectively disabled when the counter value is not equal to zero. When the counter value equals zero, the time point is equal to the 4^{th} slot SLOT[4], so the corresponding receiving modules RF_RX, ADDA_RX, BB_RX and MAC_RX of the RF, ADDA, BB and MAC chips are respectively enabled, i.e. configured to the normal mode, to set up and initialize the modules. At the time point equalling the 5^{th} slot SLOT[5], the corresponding receiving modules RF_RX, ADDA_RX, BB_RX and MAC_RX of the RF, ADDA, BB and MAC chips respectively are ready so that data transmitted from the base station can be received immediately. After an interval subsequent to the 5^{th} slot, such as the 7^{th} slot SLOT[7], the data download is completed, so the corresponding receiving modules RF_RX, ADDA_RX, BB_RX and MAC_RX of the RF, ADDA, BB and MAC chips are respectively disabled, i.e. configured to the power saving mode. It is to be understood that the corresponding receiving modules RF_RX, ADDA_RX, BB_RX and MAC_RX of the RF, ADDA, BB and MAC chips respectively can be partially or totally disabled once the data download is completed. Similarly, when the communication system operates in the transmission mode, if the time point equals the 14^{th} slot SLOT[14], the corresponding transmission modules RF_TX, ADDA_TX, BB_TX and MAC_TX of the RF, ADDA, BB and MAC chips are respectively enabled, i.e. configured to the normal mode, to set up and initialize the modules. At the time point equalling the 15^{th} slot SLOT[15], i.e. next slot, the corresponding transmission modules RF_TX, ADDA_TX, BB_TX and MAC_TX of the RF, ADDA, BB and MAC chips are respectively ready so that data can be transmitted to the base station immediately. After an interval subsequent to the 15^{th} slot, such as the 17^{th} slot SLOT[17], the data upload is completed, so the corresponding transmission modules RF_TX, ADDA_TX, BB_TX and MAC_TX of the RF, ADDA, BB and MAC chips are respectively disabled, i.e. configured to the power saving mode. It is to be understood that the counter may be countered by units other than slot (such as by time or by data length) used in this embodiment.

Furthermore, properties of other applications, such as a VoIP application, can also be used as reference parameters for power management. One property of a VoIP application, for example, is that next data may not be transmitted until several frames after the current data. In this case, the time for disabling the modules may be extended as much as possible, thereby further reducing the power consumption. Since the data to be transmitted will be put into a transmission queue, it is possible to check the transmission queue first in order to determine whether to enable the related transmission modules of the devices when the communication system operates in the transmission mode.

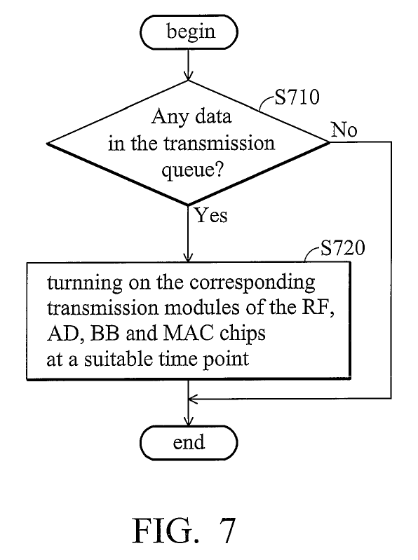

FIG. 7 is a flowchart of a power management method applied in a transmission mode according to another embodiment of the invention. When the communication system operates in the transmission mode, the transmission queue is first checked to see whether any data is in the queue (step S710). If the transmission queue is not empty (Yes in step S710), the data is to be transmitted, so the corresponding transmission modules RF_TX, ADDA_TX, BB_TX and MAC_TX of the RF, ADDA, BB and MAC chips are respectively enabled, i.e. configured to the normal mode, at a suitable time point (step S720). If the transmission queue is empty (No in step S710), no data will be transmitted, so the corresponding transmission modules RF_TX, ADDA_TX, BB_TX and MAC_TX of the RF, ADDA, BB and MAC chips are respectively disabled to save power.

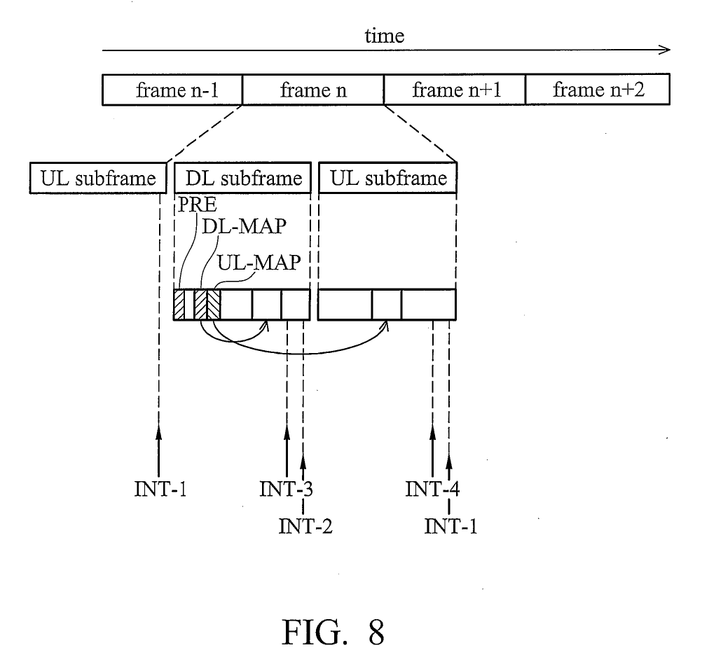

Additionally, power management of the communication system can also be achieved using interrupt vectors and executing interrupt service routines (ISR) corresponding thereto at specific time points. FIG. 8 shows an embodiment of an interrupt application according to the invention. As shown in FIG. 8, four interrupt vectors INT-1 to INT-4 are represented. When the communication system operates in the end of the UL (uplink) subframe, INT-1 is generated such that an interrupt service routine corresponding to the INT-1 in the microprocessor is triggered to perform some modularized programs. When the communication system operates in the end of the DL (download) subframe, INT-2 is generated such that an interrupt service routine corresponding to the INT-2 in the microprocessor is triggered to perform related works and programs to prepare data transmission. When the communication system operates in the DL subframe and the received data is proceeded a center level thereby, INT-3 is generated such that an interrupt service routine corresponding to the INT-3 in the microprocessor is triggered for passing the data to related applications. When the communication system operates in the UL subframe and the data upload is completed, INT-4 is generated such that an interrupt service routine corresponding to the INT-4 in the microprocessor is triggered to perform modularized programs. It is to be understood that the interrupt vectors are used as an example, not intended to limit the disclosure, and all other interrupt vectors generated at different time points can be equally applied.

The interrupt vectors provide interrupt breakpoints (time point) to determine when to disable or enable the modules. For example, the interrupt vector INT-3 provides an interrupt breakpoint to indicate that the received data has been processed and passed to high layer. In other words, the interrupt vector INT-3 provides the interval subsequent to the receiving slot. Therefore, utilizing specific time points provided by the interrupt vectors, power management in a communication system is enhanced. Detailed process and method for handling or generating interrupt vectors and interrupt service routines corresponding thereto are known to those skilled in the art, and are omitted herefrom for brevity.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded the broadest interpretation so as to encompass all such modifications and similar arrangements.

What is claimed is:

1. A method for power management in a communication system, the communication system capable of operating in a first mode and comprising at least one device, wherein the device comprises a first module corresponding to the first mode and can be configured to a normal mode or a power saving mode, the method comprising:
retrieving map data from frame data, wherein the map data indicates a first time point corresponding to the first mode; and
determining whether the first module of the device is configured to the normal mode or the power saving mode according to the first time point when the communication system operates in the first mode.

2. The method as claimed in claim 1, wherein the device is capable of operating in a second mode, and the device further comprises a second nodule corresponding to the second mode.

3. The method as claimed in claim 2, wherein the map data further indicates a second time point corresponding to the second mode, and the method further comprises determining whether the second module of the device is configured to the normal mode or the power saving mode according to the second time point when the communication system operates in the second mode.

4. The method as claimed in claim 3, wherein determining whether the second module of the device is configured to the normal mode or the power saving mode further comprises, when the communication system operates in the second mode, determining whether the first module of the device is configured to the power saving mode, and the second module of the device is configured to the power saving mode before a first interval prior to the second time point and which is configured to the normal mode at the first interval.

5. The method as claimed in claim 3, wherein determining whether the second module of the device is configured to the normal mode or the power saving mode further comprises, when the communication system operates in the second mode, determining whether the first module of the device is configured to the power saving mode, and the second module of the device is configured to the power saving mode after a second interval subsequent to the second time point.

6. The method as claimed in claim 3, further comprising determining whether the first module is configured to the power saving mode when a period between current time point and the first time point is determined to be larger than a predetermined threshold by the communication system.

7. The method as claimed in claim 6, wherein determining whether the first module is configured to the power saving mode or the normal mode further comprises, when the communication system operates in the first mode, determining the second module of the device is configured to the power saving mode, and the first module of the device is configured to the power saving mode before a third interval prior to the first time point and is configured to the normal mode during the third interval.

8. The method as claimed in claim 2, wherein determining whether the first module is configured to the power saving mode or the normal mode further comprises, when the communication system operates in the first mode, determining the second module of the device is configured to the power saving mode, and the first module of the device is configured to the power saving mode after a fourth interval subsequent to the first time point.

9. The method as claimed in claim 2, wherein the first mode is a receiving mode and the second mode is a transmission mode.

10. The method as claimed in claim 1, further comprising, when the first mode is a transmission mode, checking a transmission queue to determine whether the first module is configured to the normal mode at the first time point.

11. The method as claimed in claim 10, wherein the first module is configured to the power saving mode if the transmission queue is empty.

12. The method as claimed in claim 1, wherein the communication system is capable of performing a time division duplex (TDD) protocol.

13. The method as claimed in claim 1, wherein the communication system is capable of performing a half frequency division duplex (H-FDD) protocol.

14. The method as claimed in claim 1, wherein the device is a radio frequency (RF), base band, analog/digital converter, or medium access control (MAC) chip, or combination thereof.

15. The method as claimed in claim 1, wherein the first time point in each frame data is fixed or adjustable.

16. A communication system capable of operating in a first mode, comprising:
at least one device, comprising a first module corresponding to the first mode wherein the device can be configured to a normal mode or a power saving mode; and
a power management module, retrieving map data from frame data, wherein the map data indicates a first time point corresponding to the first mode,
wherein when the communication system operates in the first mode, the power management module determines the first module of the device is configured to the normal mode or the power saving mode according to the first time point.

17. The communication system as claimed in claim 16, wherein the device is capable of operating in a second mode, and the device further comprises a second module corresponding to the second mode.

18. The communication system as claimed in claim 17, wherein the map data further indicates a second time point corresponding to the second mode, and the power management module determines the second module of the device is configured to the normal mode or the power saving mode according to the second time point when the communication system operates in the second mode.

19. The communication system as claimed in claim 18, wherein when the communication system operates in the second mode, the power management module determines the first module of the device is configured to the power saving mode, and the second module of the device is configured to the power saving mode before a first interval prior to the second time point and which is configured to the normal mode at the first interval.

20. The communication system as claimed in claim 18, wherein when the communication system operates in the second mode, the power management module determines the first module of the device is configured to the power saving mode, and the second module of the device is configured to the power saving mode after a second interval subsequent to the second time point.

21. The communication system as claimed in claim 17, wherein the power management module configures the first module to the power saving mode when a period between current time point and the first time point is determined to exceed a predetermined threshold by the communication system.

22. The communication system as claimed in claim 21, wherein when the communication system operates in the first mode, the power management module determines the second module of the device is configured to the power saving mode, and the first module of the device is configured to the power saving mode before a third interval prior to the first time point and which is configured to the normal mode at the third interval.

23. The communication system as claimed in claim 21, wherein when the communication system operates in the first mode, the power management module determines the second module of the device is configured to the power saving mode, and the first module of the device is configured to the power saving mode after a fourth interval subsequent to the first time point.

24. The communication system as claimed in claim 23, further comprising:
an interrupt handler generating at least one interrupt vector, wherein the interrupt vector provides an interrupt breakpoint corresponding to the fourth interval; and
a microprocessor, having at least one interrupt service routine corresponding to the interrupt vector providing the interrupt service when the interrupt vector is generated.

25. The communication system as claimed in claim 23, further comprising:
an interrupt handler generating at least one interrupt vector, wherein the interrupt vector provides an interrupt breakpoint when the communication system operates in the end of the first mode; and
a microprocessor, having at least one interrupt service routine corresponding to the interrupt vector providing the interrupt service when the interrupt vector is generated.

26. The communication system as claimed in claim 20, further comprising:
an interrupt handler generating at least one interrupt vector, wherein the interrupt vector provides an interrupt breakpoint when the communication system operates in the end of the second mode; and
a microprocessor, having at least one interrupt service routine corresponding to the interrupt vector providing the interrupt service when the interrupt vector is generated.

27. The communication system as claimed in claim 20, further comprising:
an interrupt handler generating at least one interrupt vector, wherein the interrupt vector provides an interrupt breakpoint corresponding to the second interval; and
a microprocessor, having at least one interrupt service routine corresponding to the interrupt vector providing the interrupt service when the interrupt vector is generated.

28. The communication system as claimed in claim 16, wherein when the first mode is a transmission mode, the power management module checks a transmission queue to determine whether the first module is configured to the normal mode at the first time point.

29. The communication system as claimed in claim 28, wherein the first module is configured to the power saving mode if the transmission queue is empty.

30. The communication system as claimed in claim 16, wherein the communication system is capable of performing a time division duplex (TDD) protocol.

31. The communication system as claimed in claim 16, wherein the communication system is capable of performing a half frequency division duplex (H-FDD) protocol.

32. The communication system as claimed in claim 16, wherein the device is a radio frequency (RF), base band, analog/digital converter, or medium access control (MAC) chip or combination thereof.

33. The communication system as claimed in claim 32, wherein the radio frequency (RF), the base band, the converter converting between analog and digital signals, and the medium access control (MAC) chips are embedded in one or more ASIC chips.
